(19) United States
(12) Patent Application Publication
(10) Pub. No.: US 2004/0196306 A1
(43) Pub. Date: Oct. 7, 2004

(54) Method and system for flagging digital ink note content

(75) Inventors: Gregory H. Manto, Sammamish, WA (US); Steve E. Weil, Bellevue, WA (US); Michael Williams, Seattle, WA (US); Shawna Swanson, Issaquash, WA (US); Vikram Madan, Bellevue, WA (US); Michael S. Bernstein, Seattle, WA (US); Kevin P. Paulson, Redmond, WA (US); Roger Wynn, Redmond, WA (US)

Correspondence Address: BANNER & WITCOFF LTD.,, ATTORNEYS FOR MICROSOFT, 1001 G STREET , N.W., ELEVENTH STREET, WASHINGTON, DC, 20001-4597, US

(73) Assignee: Microsoft Corporation, Redmond, WA

(21) Appl. No.: 10/407,532

(22) Filed: Apr. 4, 2003

(51) Int. Cl. G09G 5/00

(52) U.S. Cl. 345/700

(57) ABSTRACT

Various techniques and tools are described for allowing a user to flag desired content within a data file. More particularly, a user can select content within a file, such as an image or a group of electronic ink strokes. The user can then flag that selected content so that it may later be easily retrieved. The flag may simply mark the position of selected content, or the flag may be associated with the selected content such that, if the content is moved to another location or even to another file, the flag will remain associated with the selected content, and can continue to be used to easily retrieve the selected content.

### FIELD OF THE INVENTION

Various embodiments of the present invention relate to the flagging of content and the subsequent retrieval of flagged content. Some embodiments of the invention have particular application to the flagging of ink content in a file, so that the flagged ink content can subsequently be retrieved for review or editing.

### BACKGROUND OF THE INVENTION

A variety of different types of electronic content are stored on computers. For example, a single user's personal computer may include text files created by a word processing program, sound files that can be played back to produce speech, music or other sounds, image files that contain pictures, or files that include a combination of different types of data. One significant advantage of electronically storing data on a computer over paper records is the ability to quickly search electronically stored content for a particular set of data. For example, with a word processing file, the entire file can quickly be searched for each occurrence of a particular word or phrase.

Some types of electronic content, however, do not lend themselves to convenient searching. For example, a conventional searching algorithm may not be able to distinguish between two images in a data file. A user thus may be unable to search for a single image in a file. Instead, without another type of indicator information (such as an image title), a user typically must manually view each image in a file in order to locate a desired image.

Similarly, some computers, such as computers employing the Microsoft Windows XP TabletPC Edition operating system, allow a user to electronically store data in the form of electronic ink. More particularly, these computers allow a user to create electronic ink strokes by moving a stylus over a digitizer, or, for example, but using a touch screen. The electronic ink strokes may include a variety of attributes, such as color and width, and can be arranged to form sketches or words in script or block lettering. Because the information represented by words written in electronic ink is only apparent after the electronic ink has been converted to text (either by a user reading the ink or by a transcription algorithm), the electronic ink cannot be easily searched in its original form. Thus, while electronic ink provides a convenient format for a user to handwrite notes, the difficulty in later searching those notes for particular information may discourage many users from employing electronic ink.

### SUMMARY OF THE INVENTION

Advantageously, various embodiments of the invention allow a user to flag desired content within a data file. More particularly, a user can select content within a file, such as an image or a group of electronic ink strokes. The user can then flag that selected content so that it may later be easily retrieved. With some embodiments of the invention, the flag may simply mark the position of selected content. With still other embodiments of the invention, however, the flag may be associated with the selected content. Thus, if the content is moved to another location or even to another file, the flag will remain associated with the selected content, and can continue to be used to easily retrieve the selected content.

The flag data defining the flag may be relatively simple. For example, the flag data may include only image data for displaying a flag image proximal to the selected content. The flag data may also define a flag image having a particular color or size, or having specific text, such as “1”, “2”, “3” or “A”, “B”, and “C.” In this manner, a user can assign basic classifications to a selected set of content. With alternate embodiments of the invention, however, the flag data can include any desired data that can be used to classify selected content. For example, the flag data may include the date that the selected content was flagged, specific category definitions (such as “business,” “personal,” “urgent,” and the like), a due date on which a task associated with the selected content must be completed, one or more user names, or any other desired attribute that may be used to classify the flag. For some embodiments of the invention, the flag data may even include content, such as image data, electronic ink data, or voice data. Thus, the flag data may include a title for the selected content or a portion of the selected content itself.

Once the selected content has been flagged, a user can easily search through the file or a plurality of files for the flagged content. With some embodiments of the invention, for example, a user can step through each flag in a file to review or edit the flagged content. Alternately or additionally, the user can review all of the flagged content within a file simultaneously. Still further, various embodiments of the invention may allow a user to view a list of pages within a document that identifies which pages contain a set of flagged content. Still other embodiments of the invention may allow a user to view a listing of flags in one or more different files, and may further allow a user to view, edit or delete one or more attributes associated with each flag. Thus, a user may view each flag in a group of files, together with a title of each flagged content or other attribute associated with the flags.

### BRIEF DESCRIPTION OF THE DRAWINGS

FIG. 1 shows a schematic diagram of a general-purpose digital computing environment that can be used to implement various aspects of the invention.

FIG. 2 illustrates a flagging tool for flagging content and retrieving flagged content.

FIGS. 3-6 illustrates different user interfaces that may be employed to retrieve flagged content for review or editing.

### DETAILED DESCRIPTION OF PREFERRED EMBODIMENTS

Overview

The present invention relates to the flagging of selected content in a file. As will be described in detail below, a user may select desired content and then flag the selected content. The user can then employ the flag to easily retrieve the selected content for viewing and editing. Various embodiments of the invention may include a tool that allows a user to select and flag a desired content. With some embodiments of the invention, the tool may allow a user to associate the flag with the content so that, even if the content is subsequently moved to another location within the file, or even to another file altogether, the flag can still be used to retrieve the content for review or editing.

Selection and flagging of content according to the multitude of possible embodiments of the invention may be implemented using a variety of techniques. For example, some embodiments of the invention may be implemented using solid state electronics. Still other embodiments of the invention may be implemented using instructions executed on a programmable computing device. Accordingly, an exemplary computing environment for executing such instructions will be described. Various interfaces demonstrating the operation and use of the invention will also be described, along with the components and functions of a flagging tool according to various embodiments the invention.

Exemplary Operating Environment

As previously noted, the content flagging techniques of the invention may be implemented using instructions that can be executed on a programmable computer, sometimes referred to as “software.” Thus, a flagging tool that allows a user to select and flag content may be described in the general context of computer-executable instructions, such as program modules, executed by one or more computing devices. Generally, program modules include routines, programs, objects, components, data structures, etc. that perform particular tasks or implement particular abstract data types. The functionality of the program modules may typically be combined or distributed as desired in various embodiments of the invention.

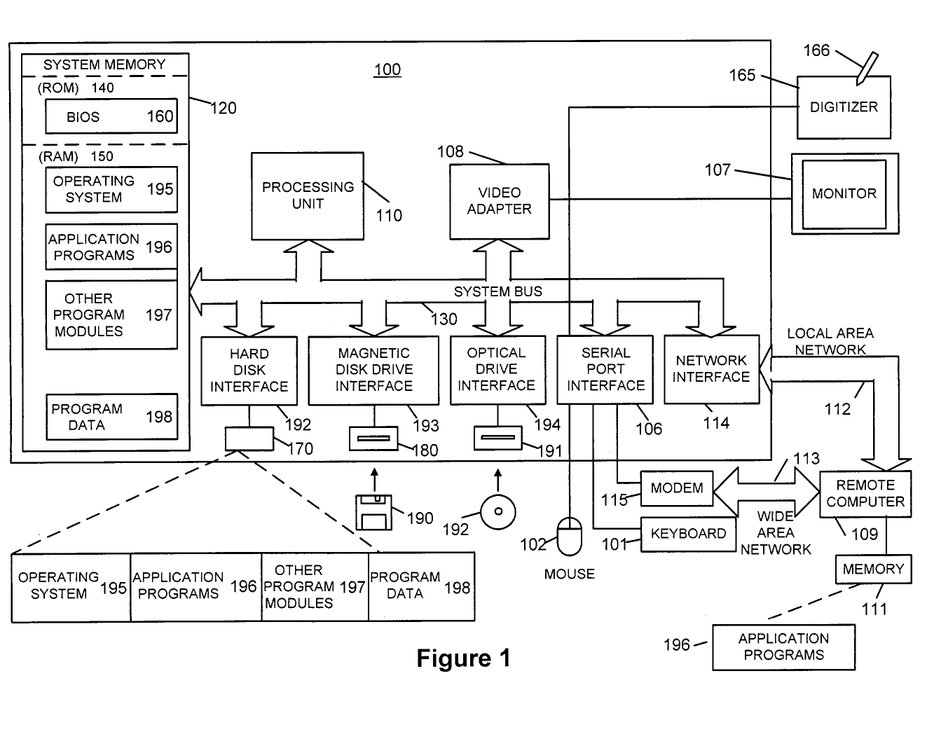

Because some embodiments of the invention can be implemented using software, it may be helpful for a better understanding of the invention to briefly discuss the components and operation of a typical programmable computer on which various embodiments of the invention may be employed. Such a computer system is illustrated in FIG. 1. The system includes a general-purpose computer 100. This computer 100 may take the form of a conventional personal digital assistant, a tablet, desktop or laptop personal computer, network server or the like.

Computer 100 typically includes at least some form of computer readable media. Computer readable media can be any available media that can be accessed by the computer 100. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computer 100.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The computer 100 typically includes a processing unit 110, a system memory 120, and a system bus 130 that couples various system components including the system memory to the processing unit 110. The system bus 130 may be any of several types of bus structures including a memory bus or memory controller, a peripheral bus, and a local bus using any of a variety of bus architectures. The system memory 120 includes read only memory (ROM) 140 and random access memory (RAM) 150. A basic input/output system 160 (BIOS), containing the basic routines that help to transfer information between elements within the computer 100, such as during start-up, is stored in the ROM 140.

The computer 100 may further include additional computer storage media devices, such as a hard disk drive 170 for reading from and writing to a hard disk, a magnetic disk drive 180 for reading from or writing to a removable magnetic disk 190, and an optical disk drive 191 for reading from or writing to a removable optical disk 192, such as a CD ROM or other optical media. The hard disk drive 170, magnetic disk drive 180, and optical disk drive 191 are connected to the system bus 130 by a hard disk drive interface 192, a magnetic disk drive interface 193, and an optical disk drive interface 194, respectively. The drives and their associated computer-readable media provide nonvolatile storage of computer readable instructions, data structures, program modules, and other data for the personal computer 100. It will be appreciated by those skilled in the art that other types of computer readable media that may store data that is accessible by a computer, such as magnetic cassettes, flash memory cards, digital video disks, Bernoulli cartridges, random access memories (RAMs), read only memories (ROMs), and the like, may also be used in the example operating environment. Also, it should be appreciated that more portable embodiments of the computer 100, such as a tablet personal computer or personal digital assistant, may omit one or more of the computer storage media devices discussed above.

A number of program modules may be stored on the hard disk drive 170, magnetic disk 190, optical disk 192, ROM 140, or RAM 150, including an operating system 195, one or more application programs 196, other program modules 197, and program data 198. A user may enter commands and information into the computer 100 through various input devices, such as a keyboard 101 and a pointing device 102 (for example, a mouse, touchpad, touch screen or pointing stick). As will be appreciated by those of ordinary skill in the art, one convenient pointing device is often a pen of stylus. Accordingly, the computing device 120 may include a digitizer 165 (sometimes referred to as a graphics pad) and a stylus or pen 166. As will be appreciated by those of ordinary skill in the art, with some embodiments, the digitizer 165 receives handwriting input when the stylus or pen 166 contacts the surface of the digitizer 165. With other embodiments, the digitizer 165 may receive handwriting input from a light beam generated by the pen 166, by tracking the angular movement of a mechanical arm supporting the pen 166, or by another suitable technique.

These and other input devices often are connected to the processing unit 110 through a serial port interface 106 that is coupled to the system bus 130, but may be connected by other interfaces, such as a parallel port, game port, IEEE-1394B bus, or a universal serial bus (USB). Further still, these devices may be coupled directly to the system bus 130 via an appropriate interface (not shown). A monitor 107 or other type of display device is also connected to the system bus 130 via an interface, such as a video adapter 108. In addition to the monitor 107, personal computers typically include other peripheral output devices (not shown), such as speakers and printers. As will be appreciated by those of ordinary skill in the art, the monitor 107 may incorporate the digitizer 165, to form a digitizing display 165. This arrangement conveniently allows a user to employ the pen 166 to point directly to objects displayed on the digitizing display by contacting the display screen of the display 165.

The computer 100 may operate in a networked environment using logical connections to one or more remote computers, such as a remote computer 109. The remote computer 109 may be a server, a router, a network PC, a peer device, or other common network node, and typically includes many or all of the elements described above relative to the computer 100, although only a memory storage device 111 with related applications programs 196 have been illustrated in FIG. 1. The logical connections depicted in FIG. 1 include a local area network (LAN) 112 and a wide area network (WAN) 113. Such networking environments are commonplace in offices, enterprise-wide computer networks, intranets, and the Internet, and thus will not be explained in detail here.

When used in a LAN networking environment, the computer 100 is connected to the local network 112 through a network interface or adapter 114. When used in a WAN networking environment, the personal computer 100 typically includes a modem 115 or other means for establishing a communications link over the wide area network 113, e.g., to the Internet. The modem 115, which may be internal or external, may be connected to the system bus 130 via the serial port interface 106. In a networked environment, program modules depicted relative to the personal computer 100, or portions thereof, may be stored in a remote memory storage device. Of course, it will be appreciated that the network connections shown are exemplary and other techniques for establishing a communications link between the computers may be used. The existence of any of various well-known protocols such as TCP/IP, Ethernet, FTP, HTTP and the like is presumed, and the system may be operated in a client-server configuration to permit a user to retrieve web pages from a web-based server. Any of various conventional web browsers may be used to display and manipulate data on web pages.

Flagging Tool

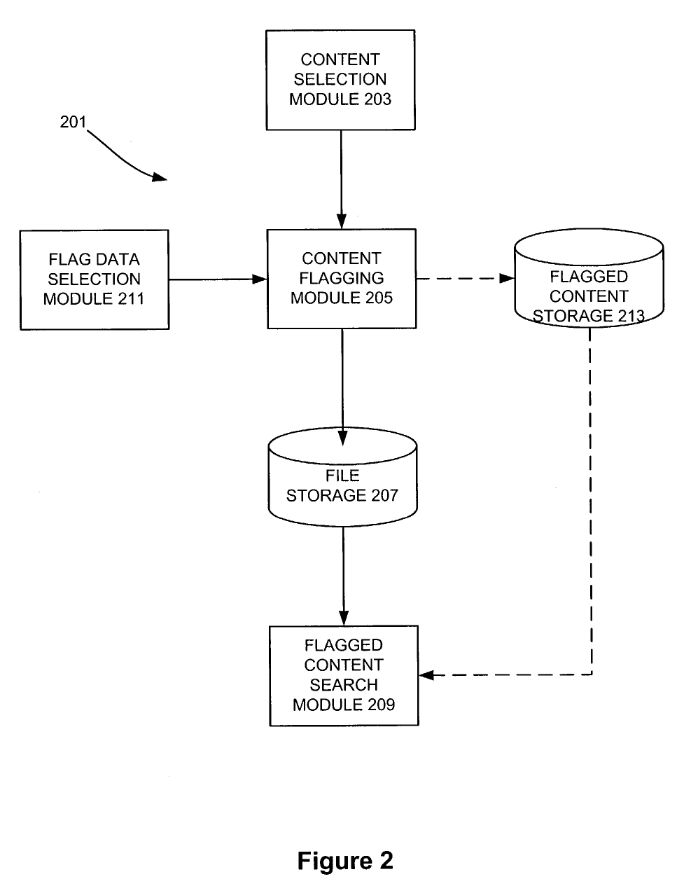

FIG. 2 illustrates one example of a flagging tool 201 according to an embodiment of the invention. As seen in this figure, the flagging tool 201 includes a content selection module 203, a content flagging module 205. The flagging tool 201 also has a file storage 207. As will be discussed in detail below, the flagging tool 201 may also optionally include a flagged content storage 213 and a flagged content search module 209.

In this illustrated embodiment, the content selection module 203 selects content to be flagged based upon input data from the user. With various embodiments of the invention, a user may employ a graphical user interface to select the content to be flagged. For example, all of the content in a file may be displayed in a conventional manner with a graphical user interface. A user may then employ a pointing device, such as a mouse, joystick, touchpad, or stylus 166 moving across a surface of a digitizer 165, to control a pointer displayed with the file's content in the graphic user interface. Based upon the user's manipulation of the pointer, the content selection module 203 may define a selection set of the displayed content. As will also be discussed in more detail below, a user may similarly employ a graphical user interface to direct the flag data selection module 211 to define the flag data for flagging selected content. With still other embodiments of the invention, however, both the content selection module 203 and the flag data selection module 211 may respond to input data provided by a user through techniques other than the use of a graphical user interface.

With some embodiments of the invention, desired content in a file may be implicitly selected by the content selection module 203. More particularly, with some embodiments of the invention, a flag is used to mark a position of the selected content within the file, and is not directly associated with the selected content itself. With these embodiments, the content selection module 203 determines the selection set of the content in the file based upon the location of the corresponding flag. For example, with some embodiments of the invention, the content selection module 203 may determine that the selected set of content is the content along a same horizontal line as the corresponding flag. More particularly, the content selection module 203 may select all of the content on a single ruled line containing a flag, all of the content on three ruled lines centered on a flag, all of the content on five ruled lines centered on a flag, and forth. Alternately, the content selection module 203 may determine that the selected set of content is all of the content within a preset distance, such as 3 inches, of a horizontal line through the corresponding flag, the entire paragraph of content closest to the flag, or even the entire page on which the flag is placed. Still other techniques for selecting a set of content based upon the content's proximity to a flag may also be employed.

Still other embodiments of the invention may explicitly select desired content in a file based upon input data from a user. For example, the content selection module 203 may select a set of content from a file based upon conventional “drag-lock” input data provided by the user. That is, a user may create the input data by activating a “drag-lock” or selection command associated with a pointing device, and then moving a pointer over the desired set of content, as is well known in the art. With some embodiments, a user may also select content by repeatedly activating a selection command (sometimes referred to as “double-clicking” or “triple-clicking”) for the desired set of content. Alternately or additionally, the content selection module 203 may select content enclosed within a bounding region defined by a user. Such a bounding region may, for example, be defined using any conventional method, including using a pointer to define two sides of a rectangular bounding box or the boundary of an irregular shape. It should be appreciated, however, that any other conventional technique for selecting data may additionally or alternately be employed to generate input data for the content selection module 203.

Flagging of Selected Content

Turning now to the content flagging module 205, the content flagging module 205 flags the selection set of content with flagging data defining a flag. As discussed above, with some embodiments of the invention, content is selected by placing a flag at a desired location with a graphical user interface displaying the content of a file. With these embodiments, the content flagging module 205 positions a flag within the content of the file based upon input data from the user. For example, a user can employ a pointing device to initiate a flagging operation, select from among one or more available flags, and then position the selected flag proximal to the content that the user wishes to flag.

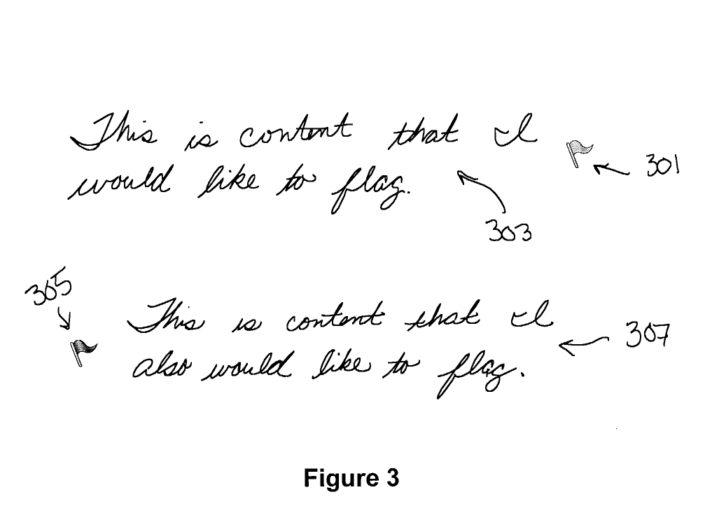

The flagging operation can be activated in any conventional manner, such as from a menu or by selecting an icon on a task bar. Similarly, if the content flagging module 205 allows the user to select from among a plurality of different types of flags, a user can employ conventional techniques, such as a pointing device, to select a flag from among the available flag types. The user may also employ conventional techniques to position the selected flag proximal to the content that the user wishes to select. For example, as illustrated in FIG. 3, the user may employ a pointing device to position a flag 301 adjacent to content 303, thereby selecting that content 303. As also illustrated in this figure, various embodiments of the invention may allow a flag 305 to be placed at any location relative to content 307 in order to select that content.

Still further, with some embodiments of the invention, the position of the flag image may be automatically placed with regard to the content. For example, with some embodiments of the invention, the flag 305 (or other marking for indicating flagged data) may be automatically placed adjacent to the content at predefined distance, or in a corner of the page with flagged content. Still further, with some embodiments of the invention, the display of the flag 305 or other marking may be omitted altogether. Instead, the appearance of the flagged content itself may be changed. For example, the color of the selected content or its immediate background may be changed to indicate that the content has been flagged.

With still other embodiments of the invention, the flag is actually associated with the selected content so that, when the selected content is moved within the file or, with some embodiments of the invention, even to another file, the selected content will remain flagged. With these embodiments, the content flagging module 205 will again flag content based upon user input provided by the user. For example, if the user has selected the set of content to be flagged in advance, the user can employ a pointing device as described above to move a flag image from an icon on a task bar “onto” the display of the selected content. Alternately, or additionally, various embodiments of the invention may allow a user to flag selected content using a menu associated with the selected content. For example, some embodiments of the invention may provide an option to flag selected content in a conventional selection menu provided for selected data. As also described above, where the content flagging module 205 allows a user to flag content with different types of flags, the user may employ any conventional selection technique to select a desired flag for flagging the selected content.

Once the user has indicated a desire to flag the selected content by, for example, moving a flag image onto the selected data, the content flagging module 205 associates the flag data defining the selected flag with the selected set of content. As noted above, with some embodiments of the invention the content selection module 203 may select content in a file based upon a bounding region defined by a user. For these embodiments, the content flagging module 205 may associate the flag data for the selected flag with all of the content data for content contained within the bounding region. For example, if the bounding region is a rectangular bounding box with defined x-coordinate and y-coordinate boundaries, then the content flagging module 205 may associate the flag with all content having position data falling within those x-coordinate and y-coordinate boundaries. With some embodiments of the invention, the flagging module 205 may associate the flag with only the content (for example, the text, pixels or electronic ink) encompassed by the bounding box when the bounding box was originally drawn. With other embodiments of the invention, however, all of the content contained within the bounding box will be flagged, regardless of when the content was included into the bounding box, thereby allowing content to be added after the flag has been established. Similarly, with some embodiments of the invention, content that is removed from the bounding box may no longer be flagged.

Alternately, if the content selection module 203 has selected specific content (that is, has selected the specific data defining the desired content), then the content flagging module 205 may create, for example, a pointer associating the selected flag with the selected content. The pointer may be a one way pointer, pointing from the flag data defining the flag to the content data defining the selected data, or the pointer may be a two way pointer between the flag data defining the flag to the content data defining the selected data. Thus, if the selected content is electronic ink, then the flag data defining the selected flag may be edited to include a pointer identifying each electronic ink stroke making up the selected content.

Still further, with some embodiments of the invention, the content flagging module 205 may actually modify the content data defining the selected content. For example, if the selected content is electronic ink, the content flagging module 205 may modify the attributes of the electronic ink to include at least a portion of the flag data defining the selected flag. Thus, rather than maintaining a pointer to separate flag data, the content data for the selected content may be modified to include the flag data defining the flag itself.

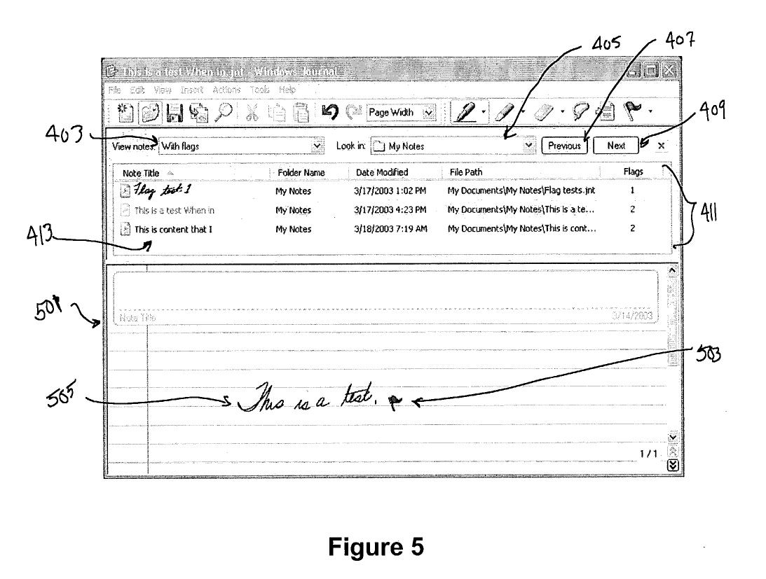

As noted above, with some embodiments of the invention, a flag simply marks the position of selected content. With these embodiments, the flag data defining the flag may be, for example, image data for illustrating a flag such as the flags 301 and 305 shown in FIG. 5, or an instruction to an application that will render the content to also render a flag or other marker with content. The content flagging module 205 may additionally offer a user a choice between different types of flag image, to allow the user to choose between flags of different colors or sizes. Thus, a user may distinguish different sets of content in a single file by flagging one set of content with, e.g., a blue flag, and flagging another set of content with a red flag.

In still other embodiments of the invention, however, the flag data defining a flag may include a variety of different types of information. For example, with some embodiments of the invention, the flag data may include date and time information, such as the date and time at which the selected content was flagged or a due date for completing a task identified by the selected content. The flag data may also additionally or alternately include priority information, such as a relative ranking of the flag. The priority data may be a numerical value, such as “1”, “2”0 or “3”, an alphabetical value, such as “A”, “B” or “C”, or a text value such as “High,” “Medium,” or “Low.” The flag data may also include any desired category definitions, such as “business,” “personal,” “urgent,” and the like, that can be used to classify selected content.

Further, the flag data may include one or more names. Thus, the flag data may include the name of the user who created the flagged content, the name of the user who flagged the selected content, the name of a person responsible for some task relating to the selected content, or, for example, if the selected content is notes taken at a meeting, the names of the meeting attendees. For some embodiments of the invention, the flag data may even include content, such as image data, electronic ink data, or voice data. Thus, the flag data may include a title identifying the selected content, or even a portion of the selected content itself. With some embodiments of the invention, when the content flagging module 205 associates a flag with selected content, the content flagging module 205 automatically modifies the flag data for the flag to include a portion of the selected content. This may allow the subject matter of the flagged content to easily be determined from the flag data alone. With some embodiments of the invention, the process of flagging content may even employ a specialized user interface for adding content to the flag data. For example, flagging content may display a “form” type user interface where a user may add content to the flag data or change the attributes of the flag. This form may be temporarily rendered, or it could be added to the file as, for example, background or a watermark.

Accordingly, for some embodiments of invention the flag data will include a variety of different types of data. With these embodiments, the flagging tool 201 may include the flag data selection module 211 to allow a user to select some or all of the flag data for a flag. With some embodiments of the invention, the flag data selection module 211 may allow a user to select specific values for the flag data. Thus, if the flag data includes date information, then the flag data selection module 211 may provide the user with an interface for setting a desired date value for the date information. The flag data selection module 211 may, for example, provide the user with a user interface in the form of a calendar. The user can then select the desired value for the date information by choosing the desired date on the calendar user interface with a pointer. It should be appreciated that any type of suitable user interface, including but not limited to a variety of graphical user interfaces, may be employed by the flag data selection module 211 to allow the user to select the desired flag data values.

The flag data selection module 211 may also allow the user to select the types of information included with the flag data. For example, with some embodiments of the invention, the flag data selection module 211 may allow a user to determine whether the flag data includes date information or priority information. The flag data selection module 211 may alternately or additionally permit the user to determine whether the flag data includes title information designated by the user, or content excerpt information that is an excerpt, summary or other information indicating the nature of the flagged content. With some embodiments of the invention, the selected content may even be moved into the flag data. With still other embodiments of the invention, the flag data selection module 211 may allow the user to select any type of information available for inclusion with the flag data. Further, as will be appreciated by those of ordinary skill in the art, any suitable conventional technique, such as the use of a variety of graphical user interfaces, can be used to allow a user to select the type of information to be included in the flag data.

With some embodiments of the invention, the attributes in the flag data for a flag may be displayed with a flag image (or other marker indicate that content has been flagged) alongside the flagged content itself. With other embodiments of the invention, the attributes of a flag may be displayed using a specialized user interface for this purpose (invoked, for example, by selecting a desired flag) or even displayed on a list of flagged content, as will be discussed in more detail below.

After the selected content in a file has been flagged, the file containing the flagged content may be stored in the file storage 207. The file storage 207 may be any conventional data storage device. For example, if the tool 201 is being implemented on a conventional personal computer, such as computer 101, the file storage 207 may be a general file storage directory maintained on the hard disk drive 170, magnetic disk 190, optical disk 192, ROM 140, or RAM 150. Typically, a file containing flagged content will be stored in the file storage 207 along with other files that may or may not contain flagged content.

In addition to storing a file with flagged content in the file storage 207, with some embodiments of the invention the content flagging module 205 stores information regarding flagged content in the flagged content storage 213. More particularly, with these embodiments of the invention, the flagged content storage 213 stores information identifying both selected content and the flag data used to flag the selected content. For example, when the content flagging module 205 flags selected content in a file, it may provide the location of the selected content to the flagged content storage 213. The content flagging module 205 may alternately or additionally provide the flagged content storage 213 with some or all of the selected content. Further, the content flagging module 205 will provide the flagged content storage 213 with at least a portion of the flag data used to flag the selected content. Thus, the flagged content storage 213 may serve as a concise record of content that has been flagged in one or more files.

Advantageously, when a user wishes to retrieve flagged content for review or editing, the flagged content storage 213 may then be searched to identify flagged content in lieu of searching the entirety of each data file that may contain flagged content. With various embodiments of the invention, the flagged content storage 213 may be implemented using any suitable technique. For example, the flagged content storage 213 may be implemented using a conventional database structure. With some embodiments of the invention, the flagged content storage 213 (or some other type of storage remote from the file storage 207) may be the only repository for the flag data. Thus, with these embodiments, the flag data is stored in a completely different location from the original file containing the flagged content. This arrangement may, for example, allow content in a file to be flagged without modifying the file itself.

With still other embodiments of the invention, when the content flagging module 205 flags selected content in a file, the content flagging module 205 may make a record identifying the flagged content at a central location in that file. For example, each time that the content flagging module 205 flags content in a file, the content flagging module 205 may store corresponding flagging information in a header or other specific portion of the file. As with the flagging information that may be stored in the flagged content storage 213, the flagging information stored in the file itself may identify the location of the flagged content and/or a portion of the flagged content. It may also include some or all of the flag data. Advantageously, when a user wishes to subsequently retrieve flagged content from the file for review or editing, the user can employ this flagging information to quickly retrieve flagged content without having to scan the entire file.

Retrieving Flagged Content

After a file with flagged content has been stored in the file storage 207, a user can employ the flagged content search module 209 to search for and retrieve flagged content from that file for review or editing. It should be appreciated, however, that while the flagged content search module 209 is illustrated in FIG. 2 as part of the flagging tool 201, with alternate embodiments of the invention the flagged content search module 209 may be separate from the flagging tool 201. For example, the flagged content search module 209 may be implemented as a separate tool or software application than the other components of the flagging tool 201.

The flagged content search module 209 according to different embodiments of the invention may provide a user with a plurality of different searching options for retrieving flagged content from a single file or from multiple files. With some embodiments of the invention, the search criteria for searching for flagged content may be selected from the same user interface employed to subsequently review or edit the retrieved content. For example, a search command can be included with, for example, with a “View” menu or other menu for the same user interface employed to review or edit content. Alternately or additionally, the flagged content search module 209 may provide the user with a specialized user interface for searching for flagged content in one or more files.

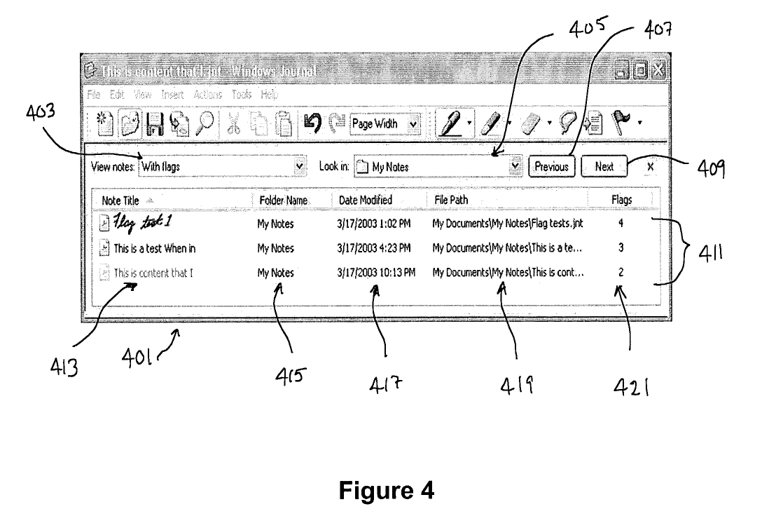

FIG. 4 illustrates a user interface 401 according to one embodiment of the invention that can be employed by a user to search for flagged content. The user interface 401 provides a search criteria field 403 for defining characteristics of a file that will be retrieved by a search. As seen in this figure, the search criteria field 403 can be configured to search for files that contain flags (that is, files that contain flag data for selected content). The user interface 401 also includes a search parameter field 405, which can be used to designate the scope of the search. Further, the user interface 401 may also include flagged content navigation buttons 407 and 409 for navigating between flagged content, as will be discussed in more detail below.

After a user has employed the user interface 401 to perform a search using the search criteria set forth in the search criteria field 403 and the search parameters set forth in the search parameter field 405, the flagged content search module 209 searches for files containing flagged content. After the search is completed, the user interface 401 displays a list of records 411 identifying the files containing the flagged content. As seen in FIG. 4, each record 411 includes a title 413 for the file containing flagged content, a location 415 for the file, in modification date 417 on which the file was last modified, and a pathway 419 to the file. As also illustrated in this figure, each record may include a flagged value 421, indicating the number of flags that were identified in the file.

It should be appreciated that the flagged content search module 209 may employ any conventional technique for searching through different files to locate files containing the flagged content. For example, with some environments of the invention, the flagged content search module 209 may scan through the entire contents of each file defined by the value in the search parameter feel 405, to locate occurrences of flagged content. If, however, the flagged content search module 209 is working with a flagging tool 201 that includes the flagged content storage 213 as described above, then the flagged content search module 209 may instead scan through the contents of the flagged content storage 213 to locate occurrences of flagged content. Still further, if the content flagging module 205 stores flagging information identifying flagged content in a central location of each file (such as a header for each file) as also described above, then the flagging content search module 209 may alternately or additionally scan this central location of each file to locate occurrences of flagged content, rather than scanning each file in its entirety.

Returning now to FIG. 4, a user may select a file included in the list of records 411 to review or edit flagged content within the file. In response, the user interface 401, according to various embodiments of the invention, may simply open the file selected by the user. In the illustrated embodiment, however, when the user selects a record 411, the content of the corresponding file is displayed within the user interface 401, as shown in FIG. 5. More particularly, as seen in this figure, the user interface 401 expands to include a content display area 501. The content display area 501 then displays the first flag 503 identified within the file, together with the content 505 that has been flagged with the flag of 503. Accordingly, the user may now review or even edit the flagged content 505.

If the user wishes to review or edit a different set of a flagged content within the file, the user may employ the flagged content navigation buttons 407 and 409 to move directly between each occurrence of flagged content within the file. For example, if the user activates the flagged content navigation button 409, then the content display area 501 will display the next occurrence of flagged content within the file. Similarly, if the user then activates the flagging content navigation button 407, the content display area 501 will display the previous occurrence of flagged content within the file (that is, it will return to the display of the flagged content 505). Accordingly, the user may employ the flagged content navigation buttons 407 and 409 to conveniently move between occurrences of flagged content within the selected file.

With some embodiments of the invention, opening a displayed record from the list 411 will only the content or only the flagged content from the file listed in that record. With alternate embodiments of the invention, however, the selection of any record from the list 411 will allow the user to review and edit all of the flagged content represented on the list 411, regardless of the file in which the flagged content occurs. For example, with some embodiments of the invention, the flagged content navigation buttons 407 and 409 may allow the user to move sequentially between the flagged content for all of the files in a list of files containing flagged content. Thus, a user can easily view and edit all of the flagged data, without having to stop to open or switch between accessing individual files.

It should be appreciated, however, that still other techniques for displaying flagged content in a file may be employed by alternate embodiments of the invention. For example, with some embodiments of the invention, the user interface 401 may simultaneously display all of the flagged content within a file or, with some embodiments of the invention, within multiple files. Thus, if a user has flagged several notes in a file or files that the user thinks are important but are at different locations, this embodiment of the invention will allow the user to simultaneously view all of the notes together without any other, unflagged content distracting the user from reviewing or editing the flagged content.

Further, with some embodiments of the invention, the user interface 401 (or equivalent user interface) may display one or more attributes of the flags, and may even allow a user to edit, add or delete attributes for a flag. For example, with the embodiment shown in FIG. 4, one or more records in the list 411 may also include attribute information for the flag or flags identified in the record. Moreover, each record may only list a single flag, in order to more clearly identify the attributes of that flag. With some of these embodiments, a user can employ the list of flagged content to view or edit the attributes of the flag data for reach listed flag. Thus, if flagged content is associated with, for example, a task to be completed, a user may modify the flag for the content when the task has actually been completed without having to retrieve the content from its file.

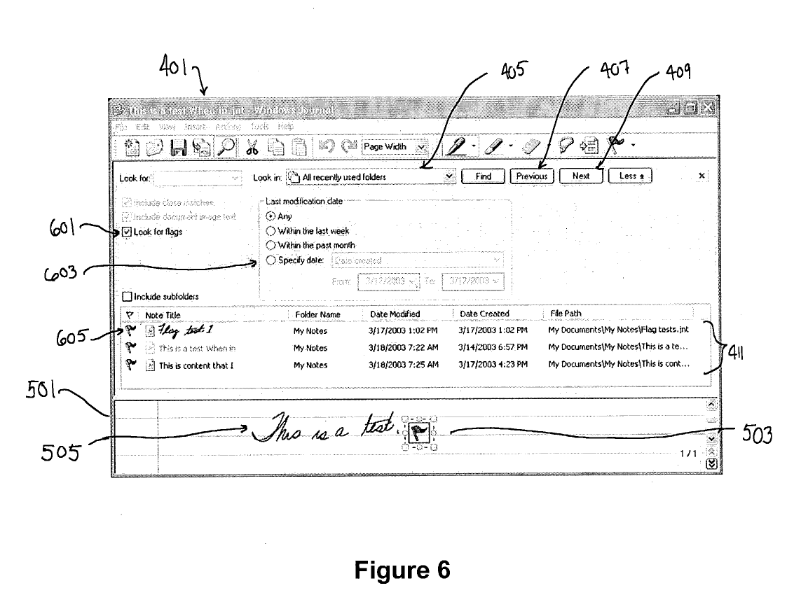

FIG. 6 illustrates yet another example of the user interface 401 that can be used to search for flagged content in one or more files. As seen in this figure, the user interface 401 allows the user to determine more selective search criteria information. More particularly, the user interface 401 includes a series of search criteria values, including a search criteria value 601 defining a search for flagged content. The search criteria values may also include other search criteria information, such as the search criteria values 605 for selecting dates on which the searched files were last modified. As also seen in this figure, the records 411 may omit the flagging value listing 421. Instead, the records 411 may include only a flagging symbol 604 indicating that the listed file contains flagged content.

Yet other embodiments of the invention may display search results for flagged content using still different techniques. For example, some embodiments of the invention may always indicate whether a file contains flagged content, regardless of whether a user has specifically initiated a search for files containing flagged content. For example, if a user interface for displaying content includes a menu command for displaying the most recently displayed files, the listing of the most recently displayed files may include the flagging symbol 604 (or other flagging symbol) to indicate which files on the list include flagged content. Similarly, the user interface employed by an operating system to allow a user to search for files system-wide may display the flagging symbol 605 (or other flagging symbol) for those files that contain flagged content. As will be appreciated by those of ordinary skill in the art, the use of the flagged content storage 213 or a central file location in each file identifying flagged content within the file may assist different applications other than the flagged content search module 209 in identifying files containing flagged content.

Still further, a variety of techniques may also be employed by different embodiments of the invention to allow a user to quickly identify where flagged content occurs within a single file. For example, a user interface displaying content in a file may include a page bar. That is, the user interface may include a bar containing multiple blocks where each block corresponds to a page in the file. If a page includes flagged content, the presence of the flagged content may be reflected on the page bar so that a user can easily determine where flagged content is located within the file. With some embodiments of the invention, the page bar may simply indicate the presence of flagged content on a page by changing the color of the block corresponding to the page, or by placing a single stripe on the block corresponding to the page. With other embodiments, however, the page bar may indicate the number of flags occurring on a page and even the types of flags occurring on a page. For example, a block in a page bar may contain a number indicating the number of occurrences of flagged content in the corresponding page. Alternately, a block in a page bar may contain a separate stripe for each occurrence of flagged content in the corresponding page. With is this embodiment, the stripes may even be color coded to indicate the types of flags (for example, the relative priority of flags) contained on the corresponding page. Of course, still other techniques may also or alternately be used to indicate the presence of flagged content throughout a file. For example, a file may include a table of contents identifying the number and types of flags located in each page. Also, a scroll bar user interface can be employed that, e.g., changes color when the user scrolls onto a page containing flagged content.

### Conclusion

As discussed above, various embodiments of the invention provide a technique that will allow a user to flag significant content for easy retrieval at a later time. Moreover, the different techniques provided by various embodiments of the invention to display files containing flagged content and then permitting a user to review and edit the flagged content may provide improved workflow for users.

Different embodiments of the invention may include the elements and steps described herein in any combination or sub combination. Accordingly, there are any number of alternative combinations for defining the invention, which incorporate one or more elements from the specification, including the description, claims, and drawings, in various combinations or sub combinations. It will be apparent to those skilled in the relevant technology, in light of the present specification, that alternate combinations of aspects of the invention, either alone or in combination with one or more elements or steps defined herein, may be utilized as modifications or alterations of the invention or as part of the invention.

What is claimed is:

1. A method of flagging content, comprising:
selecting content in a file; and
associating flag data with the selected content.

2. The method recited in claim 1, further comprising:
selecting the content by defining a bounding region containing the set of content; and
associating the flag data with the bounding region.

3. The method recited in claim 1, further comprising associating the flag data with the selected content by associating the flag data with content data defining the selected content.

4. The method recited in claim 1, further comprising associating the flag data with the selected content by modifying content data defining the selected content to include at least a portion of the flag data.

5. The method recited in claim 1, further comprising updating a data structure to include the association of the flag data with the selected content.

6. The method recited in claim 1, wherein the data structure is a database.

7. The method recited in claim 1, further comprising:
selecting a second content in the file; and
associating second flag data with the selected second content.

8. The method recited in claim 7, further comprising updating a data structure to include
an association of the first flag data with the selected first content, and
an association of the second flag data with the selected second content.

9. The method recited in claim 8, wherein the data structure is a database.

10. The method recited in claim 7, further comprising:
receiving a search request to display flag data; and
in response to receiving the search request, simultaneously displaying the first selected content and the second selected content.

11. The method recited in claim 10, further comprising displaying at least a portion of the first flag data with the displayed first selected content and displaying at least a portion of the second flag data with the displayed second selected content.

12. The method recited in claim 10, further comprising scanning the file to identify content associated with flag data.

13. The method recited in claim 10, further comprising reviewing a data structure containing associations of selected content with flag data to identify the first selected content associated with the first flag data and the second selected content associated with the second flag data.

14. The method recited in claim 7, further comprising:
receiving a search request to display flag data; and
in response to receiving the search request, displaying the first selected content.

15. The method recited in claim 14, further comprising displaying at least a portion of the first flag data with the displayed first selected content.

16. The method recited in claim 14, further comprising:
receiving a second search request to display flag data; and
in response to receiving the second search request, displaying the second selected content.

17. The method recited in claim 16, further comprising displaying at least a portion of the second flag data with the displayed second selected content.

18. The method recited in claim 14, further comprising scanning the file to identify content associated with flag data.

19. The method recited in claim 14, further comprising reviewing a data structure containing associations of selected content with flag data to identify the first selected content associated with the first flag data and the second selected content associated with the second flag data.

20. A tool for flagging content, comprising:
a content selection module that selects content in a file based upon content selection data provided by a user; and
an association module for associating flag data with the selected content.

21. The tool recited in claim 20, further comprising:
a flag data selection module that selects characteristics of the flag data based upon flag selection data provided by a user.

22. The tool recited in claim 20, further comprising:
a search module that identifies contents within a file that are associated with flag data; and
a display module for displaying at least the identified contents.

23. The tool recited in claim 22, wherein the search module searches the file to identify the contents in the file associated with flag data.

24. The tool recited in claim 22, wherein
the association module stores records of associations of selected contents with flag data in a data structure; and
the search module searches the data structure to identify the contents in a file associated with flag data.
